(19) United States
(12) Patent Application Publication
(10) Pub. No.: US 2013/0135875 A1
(43) Pub. Date: May 30, 2013

(54) LIGHT WITH A REFLECTOR AND REFLECTOR ARRANGEMENT

(71) Applicant: BA*RO GMBH & CO. KG, Leichlingen (DE)

(72) Inventors: Bernhard SCHUTTE, Langenfeld (DE); Martin KIRSTEN, Burscheid (DE); Thorsten KRETZER, Leichlingen (DE)

(73) Assignee: BA*RO GMBH & CO. KG, Leichlingen (DE)

(21) Appl. No.: 13/687,443

(22) Filed: Nov. 28, 2012

(30) Foreign Application Priority Data
Nov. 28, 2011 (DE) 202011052125.7

(51) Int. Cl. F21V 7/00

(52) U.S. Cl. CPC F21V 7/0025
USPC 362/297; 362/346

(57) ABSTRACT

The present invention relates to a light with a reflector defining a reflector axis and on its front side delimits a light outlet opening and on its rear side an illuminant opening. The reflector has reflector segments in the circumferential direction which are connected to one another. A holding plate has a central opening on the end region of the reflector and is positioned such that the holding plate opening and the illuminant opening lie over one another. An illuminant is a Lambert radiator with a circular light outlet surface radiating according to a Lambert characteristic. The Lambert radiator is fixed on the holding plate radiates light from the outside into the reflector through the illuminant opening. The reflector segments pass through the holding plate and the illuminant opening and the light outlet opening of the reflector lie on opposite sides of the holding plate.

### CROSS-REFERENCE TO RELATED APPLICATIONS AND CLAIM TO PRIORITY

This application is related to utility model application number 20 2011 052 125.7, filed Nov. 28, 2011, in the Federal Republic of Germany, the disclosure of which is incorporated herein by reference and to which priority is claimed.

### FIELD OF THE INVENTION

The present invention relates to a light with a reflector which defines a reflector axis and on its front side delimits a light outlet opening and on its rear side an illuminant opening, the reflector having a number of discrete reflector segments lying next to one another in the circumferential direction which are connected to one another, a holding plate with a central opening which is held on the end region of the reflector having the illuminant opening and is positioned such that the opening of the holding plate and the illuminant opening of the reflector lie over one another, and an illuminant which is in the form of Lambert radiator with a circular light outlet surface radiating according to a Lambert characteristic, the Lambert radiator being fixed on the holding plate and being positioned such that it radiates light from the outside into the reflector through the illuminant opening. Furthermore, the present invention relates to a reflector for such a light.

### BACKGROUND OF THE INVENTION

A light of the type described above is known from DE 20 2010 003 436 U. In this light the illuminant is formed by a so-called Lambert radiator which radiates the light in a Lambert characteristic and converts it into directed light radiation by means of a segmented reflector. The illuminant, which is in the form of an LED which has a radiating surface or light outlet surface formed according to a Lambert characteristic, is located here directly on the reflector floor, i.e. on the rear side of the reflector in the region of the illuminant opening. It is advantageous with this arrangement that in particular when using reflector materials which have a reflection-strengthening surface, a very high degree of effective light can be achieved.

Within the framework of the further development of the LED technology in lights, LED illuminants with LED fittings are increasingly being used. This leads to the light outlet surface of the Lambert radiator not lying directly on the reflector floor, but a distance away from the illuminant opening on the reflector. This leads to light losses through the fitting. Furthermore, due to the distance of the light outlet surface of the Lambert radiator from the reflector losses occur which reduce the level of effective light. If the Lambert radiator is replaced by an illuminant in the form of a point light source, light losses also occur.

### SUMMARY OF THE INVENTION

It is therefore the object of the present invention to provide a light and a reflector arrangement of the type specified at the start with which high degrees of effective light can be produced, even when the Lambert radiator is fixed by means of a fitting to the holding plate. This reflector arrangement should also be suitable for conventional light sources the light outlet body of which approximately constitutes a point-shaped light source.

This object is achieved according to the invention in that the reflector segments pass through the holding plate so that the reflector extends over the holding plate and so the illuminant opening and the light outlet opening of the reflector lie on opposite sides of the holding plate. Since the reflector passes through the holding plate, the illuminant opening and the holding plate are positioned spaced apart from one another axially. In this way the required space for installing an LED fitting is provided on which the Lambert radiator can be positioned in such a way that its light outlet surface inclines directly at the illuminant opening of the reflector. In this way light losses can be avoided. The Lambert radiator can be provided here on an LED board which is held on the LED fitting.

The central opening of the holding plate advantageously has a contour matched to the outer contour of the reflector. The central opening can thus be substantially circular in form. If the reflector has a rectangular or square basic shape, the central opening of the holding plate is also correspondingly formed.

Furthermore, there can be formed on the reflector segments contact surfaces on which the holding plate is positioned so that it is supported securely on its lower side.

According to one embodiment of the invention provision is made such that there are provided distributed along the circumference of the opening of the holding plate cut-outs through which the reflector segments pass. These reflectors can have projection-like extensions which pass through the cut-outs.

In a further configuration of this embodiment there can be provided on the reflector segments to both sides of the extensions fastening straps which pass through corresponding slots in the holding plate. The free ends of the fastening straps then project out of the holding plate and can be bent round in order to fix the reflector segments on the holding plate.

Alternatively, the holding plate can have projections arranged distributed along the circumference of the opening and protruding into the latter which engage in corresponding, in particular slot-shaped openings of the reflector segments in order to fix the holding plate on the reflector. In this configuration the projections engage in the openings of the reflector segments when the holding plate is pushed onto the reflector, and so rapid positioning and fixing is guaranteed.

In general it is desirable to produce symmetrical photographic images. In this case the reflectors are formed from a number of—in particular from two—pairs of reflector segments lying opposite one another, the reflector segments assigned to one another in pairs being curved in the same way. If an elliptical photographic image is desired, the reflector can consist, for example, of two pairs of opposing reflector segments, the two reflector segments of a pair respectively being curved in the same way, and the curves of the two pairs deviating, however, from one another. If, however, a circular photographic image is to be produced, all of the reflector segments can have the same curvature.

According to one embodiment of the invention the reflector segments can be singly spherically curved in form. In this case they have a spherical curvature in a cross-sectional plane lying perpendicular to the reflector axis, whereas in the longitudinal section they are level. Alternatively, they can be level in the cross-sectional plane lying perpendicular to the reflector axis, and be spherically curved in the longitudinal section. It is also possible to design the reflector segments twice spherically curved or planar.

According to one embodiment of the invention the reflector has a rectangular light outlet opening. In this case a pair of reflector segments forming the longitudinal sides is formed singly spherically curved, the curvature taking place in the longitudinal section plane, and a pair of reflector segments forming the face sides being planar in form.

The reflector segments can be produced easily, for example from aluminium sheet, preferably by being punched out. In this punching process, in particular the projection-type extensions, the fastening straps and the openings of the reflector segments can also be produced simply. The reflector segments are then brought by a pressing process into the desired shape before they are connected to one another at their upper and lower ends. For this purpose connection hooks that can be engaged with one another can be provided on the reflector segments. The reflector is thus easy and inexpensive to produce.

Moreover, the reflector segments can be in the form of mirror reflectors with a reflection-strengthening surface.

The reflector arrangement according to the invention is also suitable for the use of point light sources or spatially extended light sources which are in the light centre of the reflector. In order to fit the illuminant there is fixed to a holding plate a covering plate which has a central opening. The illuminant, in particular an illuminant in an upright lighting position, is then fixed on the covering plate so that it projects into the reflector coaxially to the reflector axis. The covering plate can be positioned here the desired distance away from the holding plate in such a way that the point light source used lies in the light centre of the reflector.

In order to fix the covering plate on the holding plate, there can be provided on the outer edge of the covering plate fastening straps which project in the direction of the holding plate, the free end regions of the fastening straps being bent and engaging behind the holding plate. In this configuration the covering plate can also be punched from a sheet metal material. The fixing on the holding plate can then take place simply without any further fastening means.

### BRIEF DESCRIPTION OF THE FIGURES

With regard to further advantageous embodiments of the invention reference is made to the sub-claims and to the following description of an exemplary embodiment with reference to the attached drawings. The drawings show as follows:

FIG. 1 is a perspective view of a light according to the present invention,

FIG. 2 is a longitudinal section of the light from FIG. 1,

FIG. 3 is a section A from FIG. 2 in an enlarged illustration,

FIG. 4 is a perspective exploded view of the light from FIG. 1,

FIG. 5 is a sectional exploded view of the light,

FIG. 6 is a perspective view of a reflector arrangement according to the present invention with an illuminant in the form of a point light source,

FIG. 7 is a front view of the reflector arrangement from FIG. 6,

FIG. 8 is the reflector arrangement in the longitudinal section A-A of FIG. 7,

FIG. 9 is a perspective view of the reflector arrangement with a covering plate placed on the latter,

FIG. 10 is the reflector arrangement from FIG. 9 with the covering plate removed,

FIG. 11 is section A from FIG. 10 in an enlarged illustration,

FIG. 12 is a perspective view from above, at an angle, of a further embodiment of a reflector arrangement according to the invention,

FIG. 13 is a perspective view from below, at an angle, of the reflector arrangement from FIG. 12,

FIG. 14 is a top view of the reflector arrangement from FIG. 12,

FIG. 15 is a front view of the reflector arrangement from FIG. 12,

FIG. 16 is a perspective view from above, at an angle, of a third embodiment of a reflector arrangement according to the invention,

FIG. 17 is a perspective view from below, at an angle, of the reflector arrangement from FIG. 16,

FIG. 18 is a top view of the reflector arrangement from FIG. 16,

FIG. 19 is a top view of the reflector arrangement from FIG. 16, and

FIG. 20 is a side view of the reflector arrangement from FIG. 16.

### DETAILED DESCRIPTION OF THE PREFERRED EMBODIMENT(S)

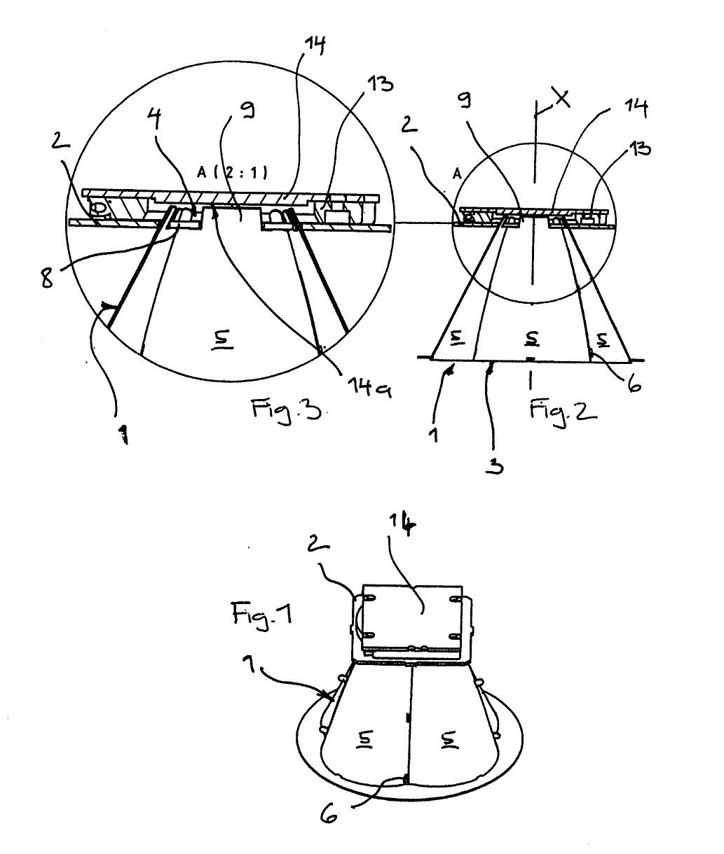

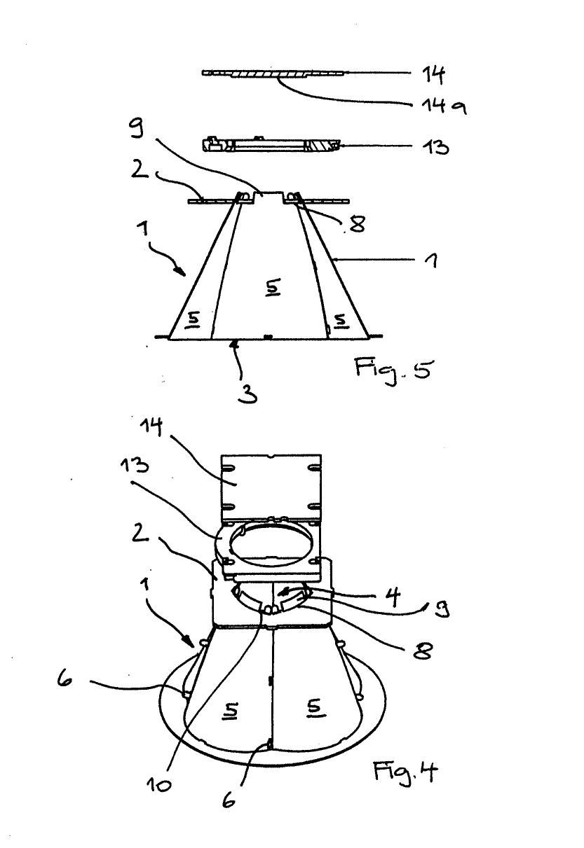

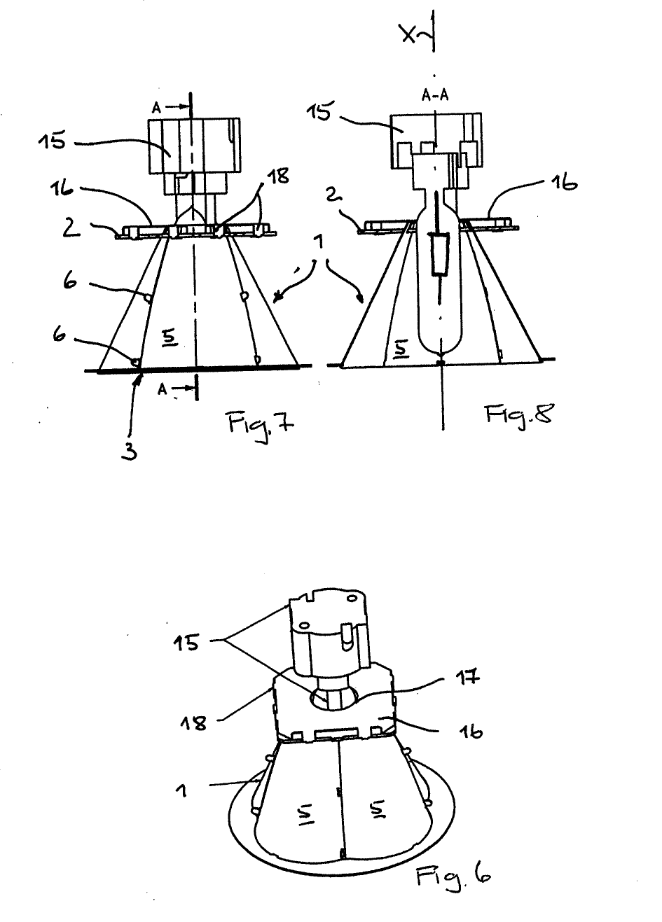

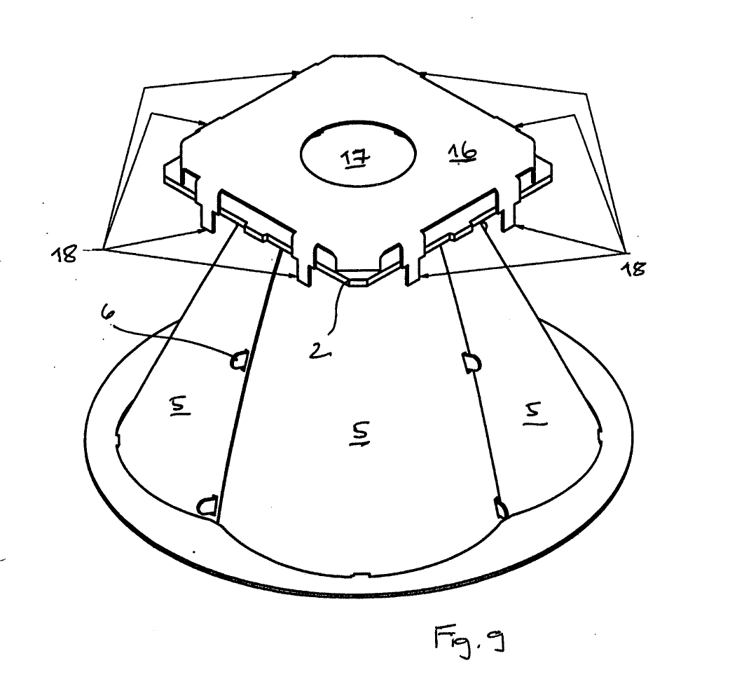

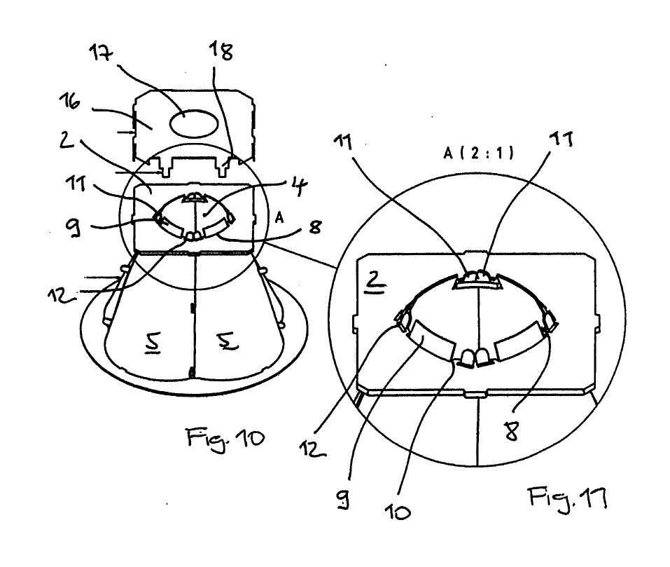

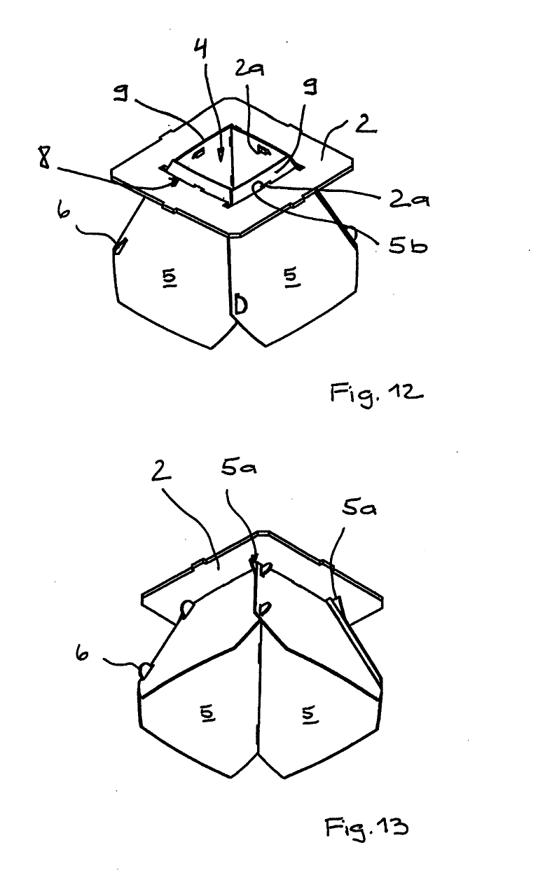

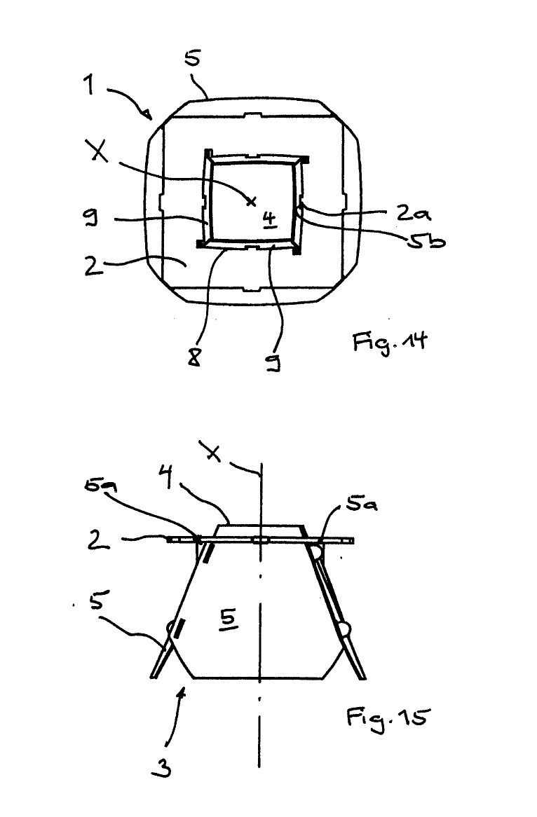

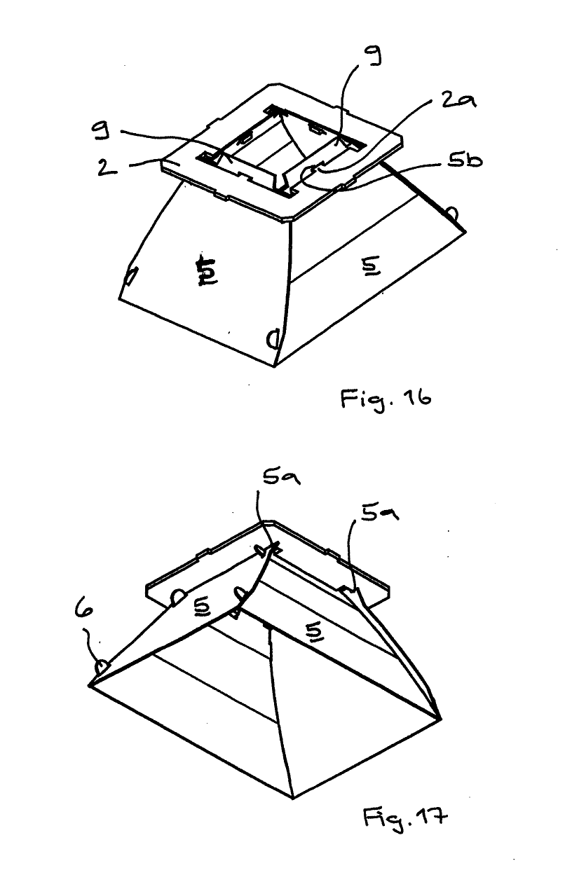

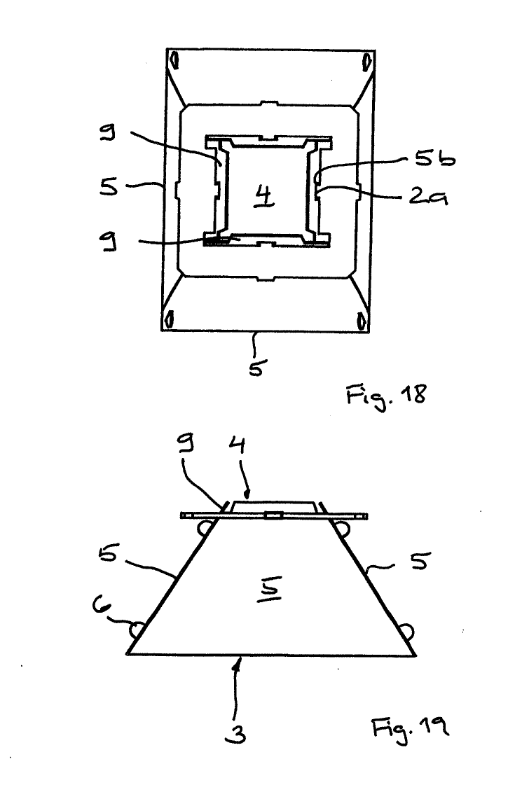

FIGS. 1 to 5 show a light according to the invention for producing an approximately circular photographic image. The light comprises a reflector arrangement with a reflector 1 and a holding plate 2 held on the latter. The reflector 1 has an open lower and front side which delimits a light outlet opening 3 of the reflector 1, and an open upper and rear side which defines an illuminant opening 4 and has a reflector axis X extending centrally between the upper side and the lower side. As can be seen easily in the drawing, the reflector 1 is formed by a total of four reflector segments 5 which are singly spherically curved in form. In other words, the reflector segments 5 have in cross-sectional planes respectively lying perpendicular to the reflector axis X a spherical curvature—this is the same in all of the reflector segments 5—while in the longitudinal section they are level in form, as is shown in particular in FIG. 2.

The reflector segments 5 are formed by discrete elements which lie next to one another in the circumferential direction and are connected to one another at their upper and lower end regions. For this purpose connection elements 6 are provided on the reflector segments 5 which can be brought into engagement, here hooked, with one another. The reflector segments 5 are produced, here punched, from aluminium sheet, and have reflection-strengthening surfaces. The reflector elements 5 are formed here such that they can be brought by a pressing process from the flat sheet form into the spherical form.

The holding plate 2 is fastened to the upper end region of the reflector 1. This plate has a circular central opening 8 matched to the shape of the reflector at the upper end of the reflector by means of which the holding plate 2 is pushed onto the upper end region of the reflector 1 so that the reflector segments 5 pass through the holding plate 2. Specifically, the reflector segments 5 have on their upper edge in the central position respectively upwardly projecting extensions 9 which are formed such that the extensions 9 of the four reflector segments 5 are spaced apart from one another in the circumferential direction. The extensions 9 pass through corresponding cut-outs 10 which are formed on the edge of the central opening 8 of the holding plate 2.

There are respectively provided to both sides of the extensions 9 on the reflector segments 5 fastening straps 11 which pass through corresponding slots 12 which are respectively formed to both sides of the cut-outs 10 in the holding plate 2 and can be bent in order to fix the holding plate 2 on the reflector 1.

A fitting 13 for a luminant 14 is fixed to the upper side of the holding plate 2. The fitting is annular in form and surrounds the extensions 9 of the reflector segments 5 which pass through the holding plate 2. The illuminant 14 is fixed to the upper side of the fitting 13. This illuminant consists of a board on which an LED is in the form of a Lambert radiator which has a circular light outlet surface 14a radiating according to a Lambert characteristic. The arrangement is made here such that the light outlet surface 14a is positioned directly above the illuminant opening 4 of the reflector 1. In other words, the extent to which the extensions 9 of the reflector segments 5 project over the holding plate 2 is chosen according to the thickness of the fitting 13 such that the light outlet surface 14a of the Lambert radiator adopts the desired position.

The reflector arrangement is also suitable for conventional illuminants the light outlet body of which constitutes approximately a point-shaped light source. As shown in FIGS. 6 to 11, in order to fix such an illuminant 15 a covering plate 16 is fixed on the upper side of the holding plate 2 which has a central opening 17 through which the illuminant 15 can be inserted into the reflector 1 from above. The covering plate 16 is positioned here above the reflector 1 in such a way that the light radiation point of the illuminant 15 lies in the light centre of the reflector 1. For this purpose the covering plate 16 is positioned at a corresponding height above the holding plate 2.

In order to fasten the covering plate 16 to the holding plate 2 there are provided on the outer edge of the covering plate 16 fastening straps 18 which are bent in the direction of the holding plate 2, the free end regions of the fastening straps 18 projecting downwards over the holding plate 2 so that they can be bent inwards in order to engage behind the holding plate 2.

FIGS. 12 to 15 show a further embodiment of a reflector arrangement according to the invention comprising a reflector 1 and a holding plate 2 held on the latter. The latter has the same basic structure as the reflector arrangement of the light shown in FIGS. 1 to 5. Specifically, the reflector 1 is formed by a total of four reflector segments 5 which are formed singly-spherically curved. As can be seen in FIG. 14, the curvature of the reflector segments 5 perpendicular to the reflector axis X is slight, however, so that the reflector 1 and so also its light outlet opening 3 and its illuminant opening 4 have an approximately square shape. So as to match the for example square shape of the reflector, the central opening 8 in the holding plate 2 is also, for example, square in shape.

Furthermore, the extensions 9 of the reflector segments 5 which pass through the central opening 8 of the holding plate 2 have a width such that they lie close to one another or come into contact at their edges.

As can be seen in particular in FIG. 13, there are formed on the reflector segments 5 contact surfaces on which the holding plate 2 is positioned. In the exemplary embodiment shown here, the contact surface 5a is formed on a side extension of the reflector segments 5.

The fastening of the holding plate 2 to the reflector 1 takes place by means of projections 2a which are arranged on the holding plate 2 distributed along the circumference of the opening 8 and project into the region of the opening 8. The projections 2a engage in the corresponding slot-like openings 5b of the reflector segments 5 and are elastically clipped securely in the latter.

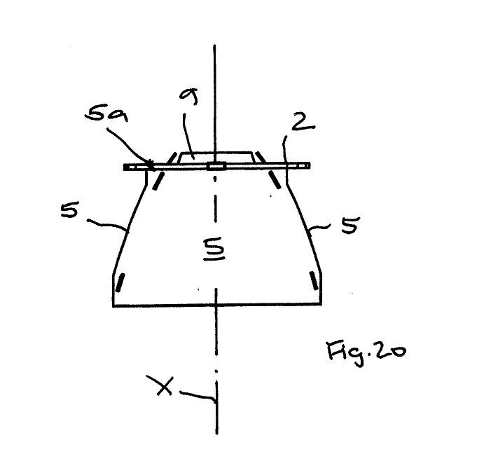

Finally, in FIGS. 16 to 20 a third embodiment of a reflector arrangement according to the invention is shown which serves to produce an oblong photographic image. The reflector 1 has a rectangular basic shape here with a rectangular light outlet opening 2 on its lower side and a rectangular illuminant opening on its upper side. The reflector 1 is formed by a total of four reflector segments 5, the two reflector segments 5 lying opposite one another and forming the longitudinal sides of the reflector 1 having a curved longitudinal section in which cross-sectional planes lying perpendicular to the reflector axis X extend in a straight line however. The other pair of reflector segments 5 forming the face sides of the reflector 1 is also level in form. As can be seen from FIGS. 17 and 18, the face side reflector segments 5 project to the side over the reflector segments 5 on the longitudinal sides, there being formed on the upper side of the protruding regions contact surfaces 5a on which the holding plate 2 is positioned.

The fixing of the holding plate 2 to the reflector 1 takes place as in the exemplary embodiment described above by means of projections 2a which are provided along the circumference of the opening 8 on the holding plate 2 and project inwardly so that they engage with corresponding openings 5b of the reflector segments 5.

The present invention has been described herein in terms of one or more preferred embodiments. However, it should be understood that numerous modifications and variations to these embodiments would be apparent to those skilled in the art upon a reading of the foregoing description. Therefore, it is intended that any such modifications and variations comprise a part of this invention, provided they come within the scope of the following claims and their equivalents.

We claim:

1. A light with a reflector (1) which defines a reflector axis (X) and on its front side delimits a light outlet opening (3) and on its rear side an illuminant opening (4), the reflector (1) having a number of discrete reflector segments (5) lying next to one another in the circumferential direction which are connected to one another, a holding plate (2) with a central opening (8) which is held on the end region of the reflector (1) having the illuminant opening (4) and is positioned such that the opening (8) of the holding plate (2) and the illuminant opening (4) of the reflector (1) lie over one another, and an illuminant (4) which is in the form of a Lambert radiator with a circular light outlet surface (14a) radiating according to a Lambert characteristic, the Lambert radiator (14) being fixed on the holding plate (2) and being positioned such that it radiates light from the outside into the reflector (1) through the illuminant opening (4), characterised in that the reflector segments (5) pass through the holding plate (2) so that the reflector (1) extends over the holding plate (2) and so the illuminant opening (4) and the light outlet opening (3) of the reflector (1) lie on opposite sides of the holding plate (2).

2. The light according to claim 1, characterised in that an LED fitting (13) is placed on the rear side of the holding plate (2) and the Lambert radiator (14) is held on the LED fitting (13).

3. The light according to claim 2, characterised in that the Lambert radiator (14) is provided on an LED board which is held on the LED fitting (13).

4. A light with a reflector (1) which defines a reflector axis (X) and on its front side delimits a light outlet opening (3) and on its rear side an illuminant opening (4), the reflector (1) having a number of discrete reflector segments (5) lying next to one another in the circumferential direction which are connected to one another, a holding plate (2) with a central opening (8) which is held on the end region of the reflector (1) having the illuminant opening (4) and is positioned such that the opening (8) of the holding plate (2) and the illuminant opening (4) of the reflector (1) lie over one another, and an illuminant (15) which is fixed to the holding plate (2), characterised in that the reflector segments (5) pass through the holding plate (2) so that the reflector (1) extends over the holding plate (2) and so the illuminant opening (4) and the light outlet opening (3) of the reflector (1) lie on the opposite side of the holding plate (2), and that there is fixed to the holding plate (2) a covering plate (16) which has a central opening (17), an illuminant (15), in particular in an upright position, being fixed on the covering plate (16) and projecting into the reflector (1) coaxially to the reflector axis (X).

5. The light according to claim 4, characterised in that there are provided on the outer edge of the covering plate (16) fastening straps (18) which project in the direction of the holding plate (2), the free end regions of the fastening straps (18) being bent and engaging behind the holding plate (2).

6. The light according to claim 3, characterised in that the central opening (8) of the holding plate (2) has a contour matched to the outer contour of the reflector (1).

7. The light according to claim 6, characterised in that the central opening (8) of the holding plate (2) is substantially circular in form.

8. The light according to claim 6, characterised in that the central opening (8) of the holding plate (2) has a rectangular or square basic shape.

9. The light according to claim 3, characterised in that there are formed on the reflector segments (5) contact surfaces (5a) on which the holding plate (2) is positioned.

10. The light according to claim 3, characterised in that there are provided distributed along the circumference of the opening (7) of the holding plate (2) cut-outs (10) through which reflector segments (5) pass.

11. The light according to claim 10, characterised in that the reflector segments (5) have projection-like extensions (9) which pass through the cut-outs (10).

12. The light according to claim 11, characterised in that there are provided on the reflector segments (5) to both sides of the extensions (9) fastening straps (11) which pass through corresponding slots (12) in the holding plate (2).

13. The light according to claim 3, characterised in that the holding plate (2) has projections (2a) arranged distributed along the circumference of the opening (8) and protruding into the latter which engage in corresponding, in particular slot-shaped openings (5b) of the reflector segments (5) in order to fix the holding plate (2) on the reflector (1).

14. The light according to claim 3, characterised in that pairs of reflector segments (5) lying opposite one another are curved in the same way.

15. The light according to claim 14, characterised in that at least one pair of opposing reflector segments (5) is formed singly spherically curved.

16. The light according to claim 14, characterised in that at least one pair of opposing reflector segments (5) has planar reflector surfaces.

17. The light according to claim 14, characterised in that the reflector (1) has a rectangular light outlet opening (3) and that a pair of reflector segments (5) forming the longitudinal sides is formed singly spherically curved, the curvature taking place in the longitudinal section plane, and a pair of reflector segments (5) forming the face sides being planar in form.

18. The light according to claim 3, characterised in that the reflector segments (5) are in the form of mirror reflectors with a reflection-strengthening surface.

19. A reflector arrangement with a reflector (1) which defines a reflector axis (X) and on its front side delimits a light outlet opening (3) and on its rear side an illuminant opening (4), the reflector (1) having a number of discrete reflector segments (5) lying next to one another in the circumferential direction which are connected to one another, and a holding plate (2) with a central opening (8) which is held on the end region of the reflector (1) having the illuminant opening (4) and is positioned such that the opening (8) of the holding plate (2) and the illuminant opening (4) of the reflector (1) lie over one another, characterised in that the reflector segments (5) pass through the holding plate (2) so that the reflector (1) extends over the holding plate (2) and so the illuminant opening (4) and the light outlet opening (3) of the reflector (1) lie on opposite sides of the holding plate (2).

20. The reflector arrangement according to claim 19, characterised in that the central opening (8) of the holding plate (2) has a contour matched to the outer contour of the reflector (1).

21. The reflector arrangement according to claim 20, characterised in that the central opening (8) of the holding plate (2) is substantially circular in form.

22. The reflector arrangement according to claim 20, characterised in that the central opening (8) of the holding plate (2) has a rectangular or square basic shape.

23. The reflector arrangement according to claim 19, characterised in that there are formed on the reflector segments (5) contact surfaces (5a) on which the holding plate (2) is positioned.

24. The reflector arrangement according to claim 19, characterised in that there are provided distributed along the circumference of the opening (8) of the holding plate (2) cut-outs (10) through which reflector segments (5) pass.

25. The reflector arrangement according to claim 24, characterised in that the reflector segments (5) have projection-like extensions (9) which pass through the cut-outs (10).

26. The reflector arrangement according to claim 25, characterised in that there are provided on the reflector segments (5) to both sides of the extensions (9) fastening straps (11) which pass through corresponding slots (12) in the holding plate (2).

27. The reflector arrangement according to claim 19, characterised in that the holding plate (2) has projections (2a) arranged distributed along the circumference of the opening (8) and protruding into the latter which engage in corresponding, in particular slot-shaped openings (5b) of the reflector segments (5) in order to fix the holding plate (2) on the reflector (1).

28. The reflector arrangement according to claim 19, characterised in that there is fixed on the holding plate (2) a covering plate (19) which has a central opening (17).

29. The reflector arrangement according to claim 28, characterised in that there are provided on the outer edge of the covering plate (16) fastening straps (18) which project in the direction of the holding plate (2), the free end regions of the fastening straps (18) being bent and engaging behind the holding plate (2).

30. The reflector arrangement according to claim 19, characterised in that pairs of reflector segments (5) lying opposite one another are curved in the same way.

31. The reflector arrangement according to claim 30, characterised in that at least one pair of opposing reflector segments (5) is formed singly spherically curved.

32. The reflector arrangement according to claim 30, characterised in that at least one pair of opposing reflector segments (5) has planar reflector surfaces.

33. The reflector arrangement according to claim 30, characterised in that the reflector (1) has a rectangular light outlet opening (3) and that a pair of reflector segments (5) forming the longitudinal sides is formed singly spherically curved, the curvature taking place in the longitudinal section plane, and a pair of reflector segments (5) forming the face sides being planar in form.

34. The reflector arrangement according to claim 19, characterised in that the reflector segments (5) are in the form of mirror reflectors with a reflection-strengthening surface.
